(19) United States
(12) Patent Application Publication
(10) Pub. No.: US 2003/0127425 A1
(43) Pub. Date: Jul. 10, 2003

(54) System and method for etching resin with an ozone wet etching process

(76) Inventors: Hirohiko Nishiki, Tenri-shi (JP); James M. Atkinson, Camas, WA (US); Yukihiko Nakata, Nara City (JP)

Correspondence Address: David C. Ripma, Patent Counsel, Sharp Laboratories of America, Inc., 5750 NW Pacific Rim Boulevard, Camas, WA, 98607, US

(21) Appl. No.: 10/040,646

(22) Filed: Jan. 7, 2002

(51) Int. Cl. B29D 11/00

(52) U.S. Cl. 216/24

(57) ABSTRACT

A method is provided for cleaning resin residue in liquid crystal display (LCD) or integrated circuit (IC) fabrication process. The method comprises: forming an electrode layer; forming an interlayer film of resin overlying the electrode later; patterning the resin interlayer; forming a via to access the first area of the electrode layer; in response to forming the via, forming a resin residue overlying a first area of the electrode layer; introducing a gas mixture including ozone into water to create a moist ozone gas, where the gas mixture is approximately 10% ozone by molecular weight (wt %); wet ashing the resin residue overlying the first area of the electrode layer using the moist ozone gas; and, depositing a metal layer overlying the first area of the electrode to form a pixel electrode.

### BACKGROUND OF THE INVENTION

1. Field of the Invention

This invention generally relates to liquid crystal display (LCD) and integrated circuit (IC) fabrication and, more particularly, a method for etching resin, and repairing a resin surface using an ozone wet etching process.

2. Description of the Related Art

An LCD panel is indispensable for notebook type personal computers (PCs) because of its light weight and thin profile, as compared to a cathode ray tube (CRT) monitor. In addition, the energy consumption of the LCD panel is much lower than that of CRT. The price of LCD monitors continues to decrease, but they are still more expensive than CRTs. Hence, further cost reduction is required before LCDs become economical enough to replace CRTs. In addition, the image quality of LCD panels is generally not as good as that of a CRT. To improve the image quality and to decrease energy consumption, the aperture ratio of LCD panel must be as large as possible.

Recently, a pixel-on-passivation (POP) structure has been adopted for thin film transistor (TFT) LCD panels, to increase the aperture ratio. The transistors are built on layers that provide greater pixel area. To accomplish this, low k dielectric and gate insulator layers are required. Resin is a low k dielectric. Therefore, POP structures use organic materials, such as resin, as an interlayer insulator. Photodefinable resin can be spin-coated on a substrate, exposed, and patterned by conventional photo processes. After patterning, the resin is cured in a furnace. Non-photodefinable resin is patterned with an overlying photoresist layer. After patterning, the resin is dry etched. However, process issues exist with the use of interlayer resin materials. Due to imcomplete patterning or process deviations, very thin layers of resin residue often remain following the pattern etching process. This residue is especially a problem in via through holes, and can result in the failure of electrical connections between the drain node and a pixel electrode of a TFT transistor.

In order to prevent this electrical connection failure, an O2 dry ashing treatment is usually performed after the resin curing process to remove the resin residue. However, the dry ashing can be harmful to any exposed resin surfaces.

In other processes, the interlayer resin is used as a etching barrier, like photoresist. For example, a SiNx passivation layer under the resin is sometimes dry etched by using the resin as a photoresist. However, the resin is severely damaged by the CF4+02 plasma used to etch the passivation layer. Interlayer resin that is exposed to high-energy plasma develops severe damage in the surface region. This surface damage results in a poor film quality pixel electrode, which is usually formed from ITO (Indium Tin Oxide) or aluminum overlying molybdenum (Al/Mo). The poor film quality has a deleterious effect upon the adhesion of the pixel electrode to the interlayer resin. The poor film quality and adhesion issues involved with the use of resin as an interlayer material must be addressed in order to improve production yield and panel quality.

It would be advantageous if POP electrical connection failures, due to resin residue between conducting layers, could be prevented.

It would be advantageous if interlayer resin film damage could be prevented, to improve adhesion to subsequently deposited layers.

It would be advantageous if processes could be developed for cleaning resin residue, and for repairing resin surfaces that have been damaged in dry etching processes.

### SUMMARY OF THE INVENTION

As a result of the problems in the use of interlayer resin materials, the present invention processes were developed to more easy remove resin residue from the surface of a conductant such as Al or ITO. The present invention process also acts to repair resin surfaces that have been damaged by dry etch plasma processes, to improve the adhesion of the resin surface to subsequently deposited film layers.

Accordingly, a method is provided for cleaning resin residue in a LCD or IC fabrication process. The method comprises: forming an electrode layer; forming an interlayer film of resin overlying the electrode later; patterning the resin interlayer; forming a via to access the first area of the electrode layer; in response to forming the via, forming a resin residue overlying a first area of the electrode layer; introducing a gas mixture including ozone into water to create a moist ozone gas, where the gas mixture is approximately 10% ozone by molecular weight (wt %); wet ashing the resin residue overlying the first area of the electrode layer using the moist ozone gas; and, depositing a metal layer overlying the first area of the electrode to form a pixel electrode.

Additional details of the above-mentioned resin residue cleaning process, as well as a method for repairing a resin interlayer surface, are presented below.

### BRIEF DESCRIPTION OF THE DRAWING

FIGS. 1a through 1d are partial cross-sectional views of a transistor structure illustrating steps in the present invention process of cleaning a resin residue.

FIGS. 2a through 2d are partial cross-sectional views of the transistor structure illustrating steps in the present invention process of repairing a damaged interlayer resin surface.

FIG. 3 is a graph illustrating a comparison between a water solution with a dissolved ozone (dissolved O3) and a moist ozone gas (moist O3).

FIG. 4 is a flowchart illustrating the present invention method for cleaning a resin residue in a LCD fabrication process.

FIG. 5 is a flowchart illustrating the present invention method for repairing a resin interlayer surface in a LCD fabrication process.

FIG. 6 is a flowchart illustrating an alternate method for repairing a resin interlayer surface in a LCD fabrication process.

FIG. 7 is a flowchart illustrating an alternate method for cleaning a resin residue in a LCD fabrication process.

### DETAILED DESCRIPTION OF THE PREFERRED EMBODIMENTS

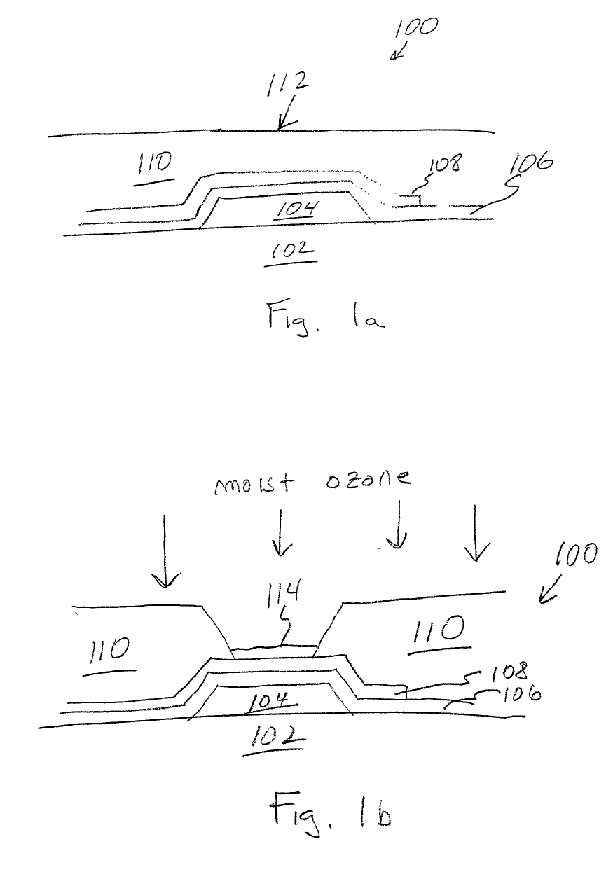

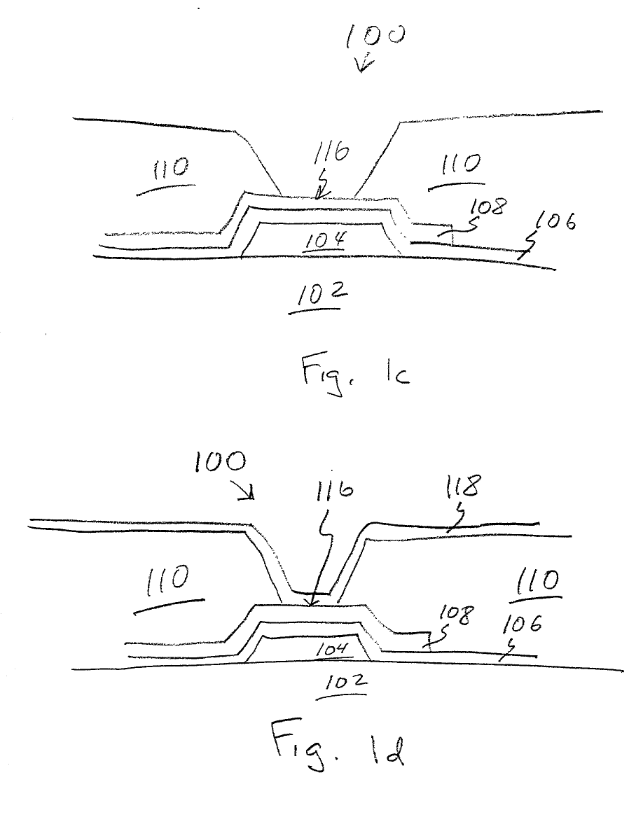

FIGS. 1a through 1d are partial cross-sectional views of a transistor structure 100 illustrating steps in the present invention process of cleaning a resin residue. It should be understood that although the present invention is described in the context of LCD fabrication processes, the present invention methods are more generally applicable to IC fabrication processes where resin interlayers are used. Further, although bottom gate transistor structures are explicitly shown, the present invention method is not limited to any particular transistor structure.

In FIG. 1a, the transistor structure 100 is built over a glass or plastic substrate 102. Overlying the substrate 102 is a gate busline 104. Overlying the substrate 102 and the gate busline 104 is a gate insulator 106. Overlying the gate insulator 106 is a drain electrode 108. A resin interlayer 110 overlies the drain electrode 108. The resin interlayer 110 is subsequently patterned in area 112, so as to expose the underlying drain electrode 108. The resin interlayer 110 can be photodefinable (patterned like photoresist), or a non-photodefinable resin interlayer can be patterned with an overlying photoresist layer (not shown).

In FIG. 1b, the resin interlayer 110 has been etched to form a via to the underlying drain electrode 108 using a dry etch process. For example a dry etch process using a CF4+02 plasma. However, it should be understood that the invention is not limited to any particular type of etching process, as other high energy plasma etchants produce equivalent residues. The etching, however performed, normally leaves an undesired resin residue 114.

In FIG. 1c, the transistor structure 100 is exposed to the moist ozone etching process, as described in detail below. The moist ozone process removes the residue 114, exposing an area 116 of the drain electrode. With area 116 exposed, a good electrical contact can be made between the drain electrode area 116 and a subsequently deposited conductive layer (see FIG. 1d).

In FIG. 1d, an electrically conductive layer 118 has been deposited over the drain electrode area 116, as well as over the resin interlayer 110. The moist ozone etching process does not damage the surface of the interlayer resin 110, permitting the conductive layer 118 to adhere to the interlayer resin 110.

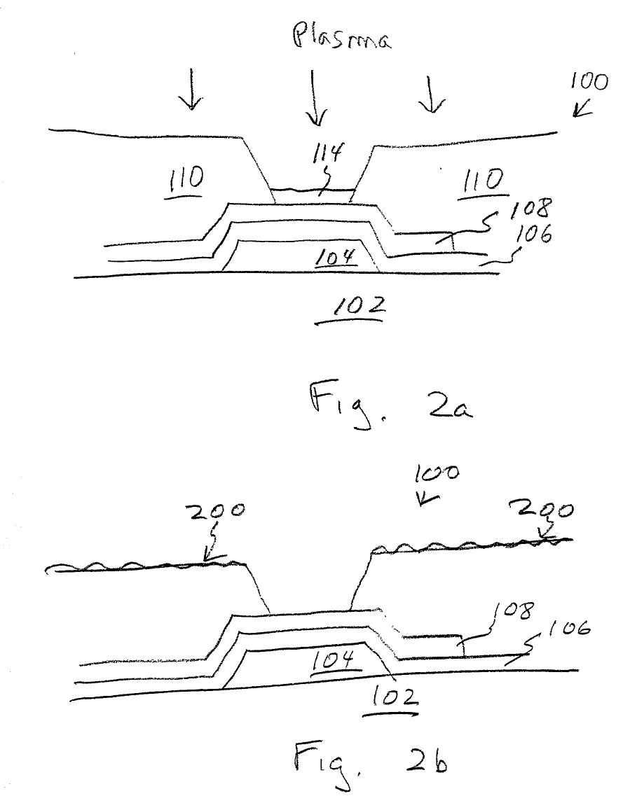

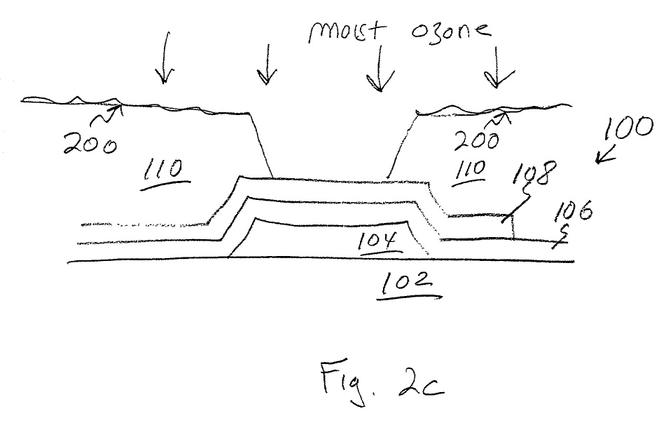

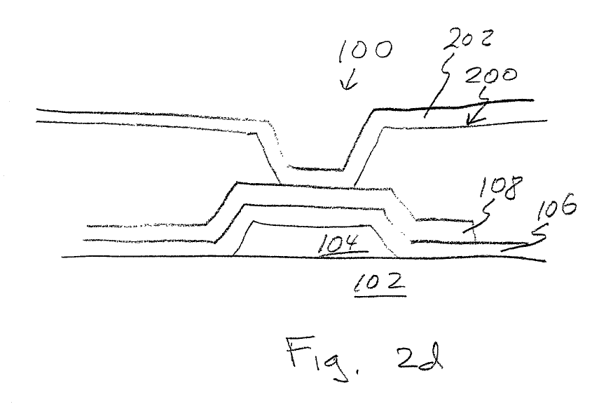

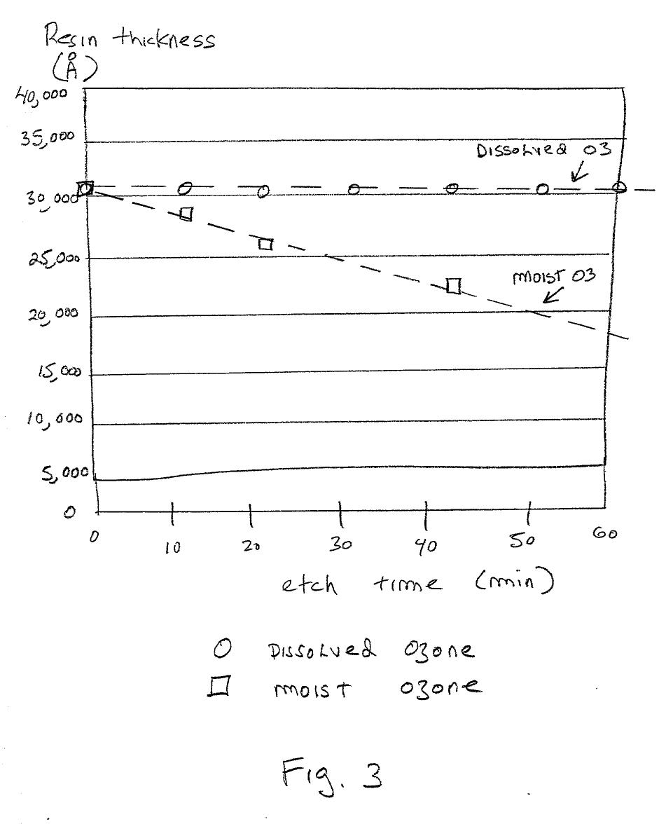

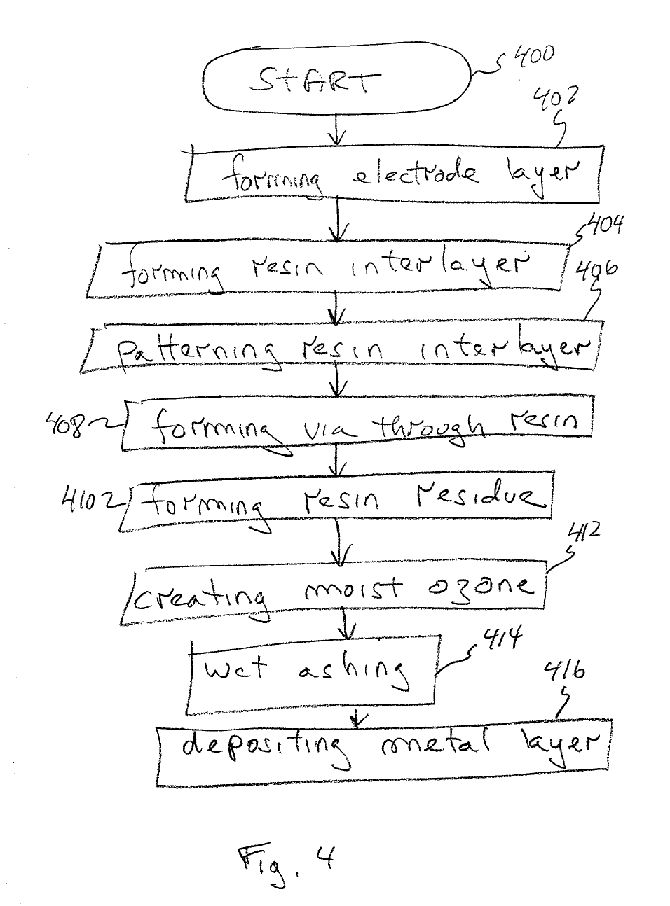

FIGS. 2a through 2d are partial cross-sectional views of the transistor structure 100 illustrating steps in the present invention process of repairing a damaged interlayer resin surface. FIG. 2a is essentially the same as FIG. 1b. An area of resin residue exists that must be cleaned. The resin cannot be removed by a developer. In this scenario, a dry etch process using oxygen and a high energy plasma is used to remove the residue.

FIG. 2b depicts the results of the dry etching process. Although the residue 114 (see FIG. 2a) has been removed, the surface 200 of the interlayer resin 110 has been damaged. If an electrically conductive layer, such as a pixel layer (not shown), is deposited over the damaged interlayer resin 200, it is unlikely that the deposited layer will adhere correctly to the resin surface 200.

In FIG. 2c, the interlayer resin surface is treated with the moist ozone surface repair process discussed in greater detail below. The moist ozone gas has much lower energy than the radicals or ions in a dry etching plasma.

In FIG. 2d, the resin surface has been repaired and an electrically conductive layer 202 has been deposited over the resin surface 200. Because of the surface repair process, the adhesion between the resin surface 200 and the conductive layer 202 is good.

FIG. 3 is a graph illustrating a comparison between a water solution with a dissolved ozone (dissolved O3) and a moist ozone gas (moist O3). The moist ozone solution has a higher concentration of ozone than can be obtained by simply dissolving ozone in water. As can be seen from the graph, the moist ozone has a significantly better etch rate than the dissolved ozone. In some aspects of the invention, the moist ozone etching, and/or surface repairing process uses a high temperature water solution, between 80 and 95 degrees C. (approximately 90 degrees C.), and a high concentration ozone gas, approximately 10% by molecular weight (approximately 10 wt %). Variations in the temperature and ozone concentrate can be expected to compensate for differences in material thicknesses, machinery, and process specifics. It is known to increase the concentration of ozone in a water solution by either adding the ozone under pressure, are adding the ozone to water, at a water temperature of approximately 8 degrees C.

The present invention stripping and repairing process can be accomplished using conventional processing equipment, such as from either IMEC or Semitool, Inc. Both these tools use a process where a thin water layer is formed on the substrate to be treated, and ozone gas is blown to the thin water layer. The difference between IMEC's and Semitool's process is in the manner of keeping the water layer thin. In IMEC's process, the substrate is kept upside down, and ozone gas with moisture is supplied to the substrate from below. In Semitool the process, the substrates are rotated at a rate in the range of 800 to 1500 revolutions per minute (rpm). Hot water (approximately 90 degrees C.) is supplied by one supply line and ozone gas is blown onto the substrate by another supply line. The present invention process can be made to work with either of these processes.

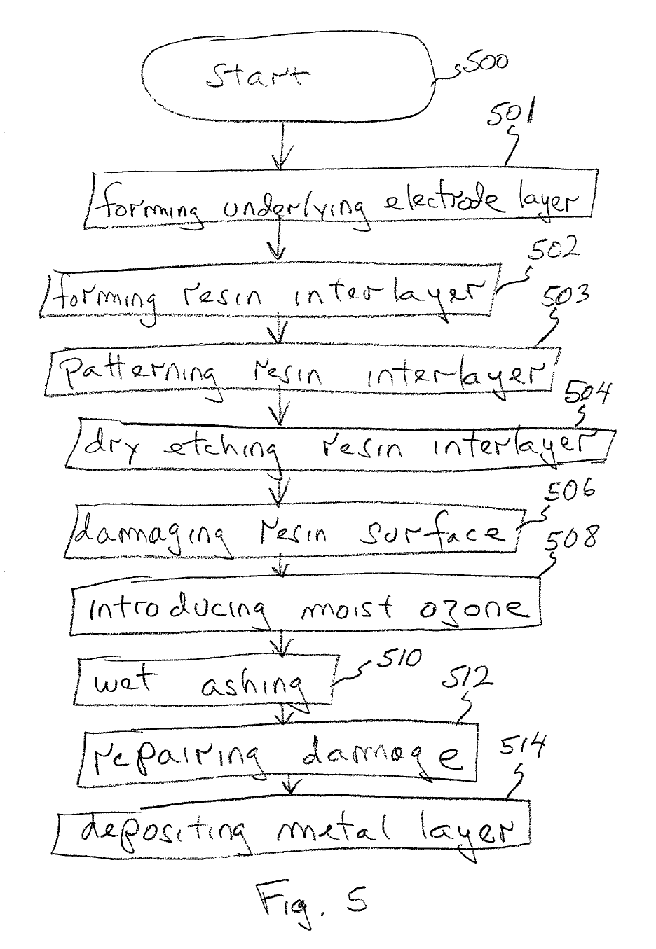

FIG. 4 is a flowchart illustrating the present invention method for cleaning a resin residue in a LCD fabrication process. Although the method, and the other methods described below, is depicted as a sequence of numbered steps for clarity, no ordering should be inferred from the numbering unless explicitly stated. The method starts at Step 400. Step 402 forms an electrode layer. Following the forming of an electrode layer in Step 402, Step 404 forms an interlayer film of resin overlying the electrode later. Step 406 patterns the resin interlayer. Step 408 forms a via to access the first area of the electrode layer. Step 410, in response to forming a via in Step 408, forms a resin residue overlying a first area of the electrode layer.

Step 412 introduces a gas mixture including ozone into water to create a moist ozone gas. Step 414 wet ashes the resin residue overlying the first area of the electrode layer using the moist ozone gas. Typically, wet ashing the resin residue in Step 414 includes etching the resin residue at a rate of 200 Å per minute. Following wet ashing the resin residue overlying the first area of the electrode layer in Step 414, Step 416 deposits a metal layer overlying the first area of the electrode to form a pixel electrode.

Forming an interlayer film of resin overlying an electrode layer in Step 404 includes forming an interlayer film of resin having a thickness in the range of 100 to 1000 Angstroms (Å).

Introducing a gas mixture including ozone into water to create a moist ozone gas in Step 412 includes introducing a gas mixture of approximately 10% ozone by molecular weight (wt %). In some aspects of the invention Step 412 heats the water to a temperature of approximately 90 degrees C. (80 to 95 degrees C.) and the ozone is introduced to the heated water.

Depositing a metal layer overlying the first area of the electrode to form a pixel electrode in Step 416 includes depositing a metal layer material selected from the group including indium tin oxide (ITO) and aluminum overlying molybdenum.

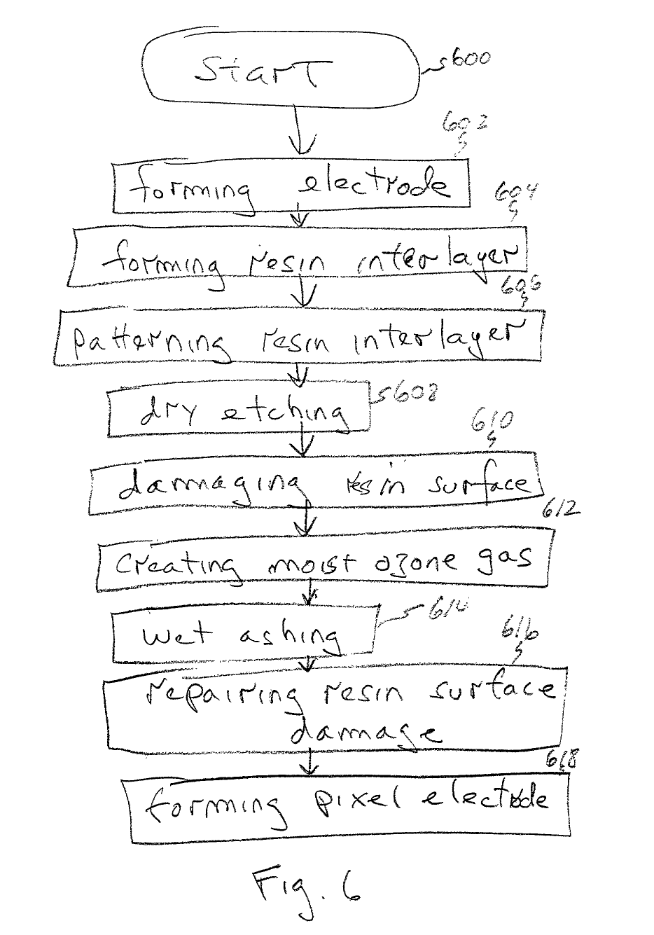

FIG. 5 is a flowchart illustrating the present invention method for repairing a resin interlayer surface in a LCD fabrication process. The method begins at Step 500. Prior to forming an interlayer film of resin, Step 501 forms an underlying electrode layer having a thickness in the range of 100 to 1000 Angstroms (Å). Step 502 forms an interlayer film of resin with a surface. Following Step 502, Step 503 patterns the resin interlayer. Step 504 dry etches the surface of the resin interlayer. Step 504 includes forming a via to access a first area of the electrode layer using a dry etching process. In some aspects of the invention, dry etching the surface of the resin interlayer includes dry etching with a plasma including CF4 and O2.

Step 506, in response to dry etching, damages the resin interlayer surface. Step 508 introduces a gas mixture including ozone into water to create a moist ozone gas. Step 510 wet ashes the resin interlayer surface using the moist ozone gas. Step 512, in response to wet ashing the resin interlayer surface, repairs the damage caused by the dry etching. Following wet ashing the resin interlayer surface in Step 512, Step 514 deposits a metal layer overlying the resin interlayer surface and the first area of the electrode to form a pixel electrode.

Introducing a gas mixture including ozone, into water to create a moist ozone gas in Step 508 includes introducing a gas mixture of approximately 10% ozone by molecular weight (wt %). In some aspects of the invention, Step 508 heats the water to a temperature of approximately 90 degrees C. (80 to 95 degrees C.).

Depositing a metal layer overlying the resin interlayer surface and the first area of the electrode to form a pixel electrode in Step 514 includes depositing a metal layer material selected from the group including indium tin oxide (ITO) and aluminum overlying molybdenum.

Wet ashing the resin interlayer surface using the moist ozone gas in Step 510 includes etching the resin interlayer surface at a rate of 200 Å per minute. In some aspects of the invention, Step 510 includes etching the resin interlayer surface a thickness in the range of 100 to 500 Å.

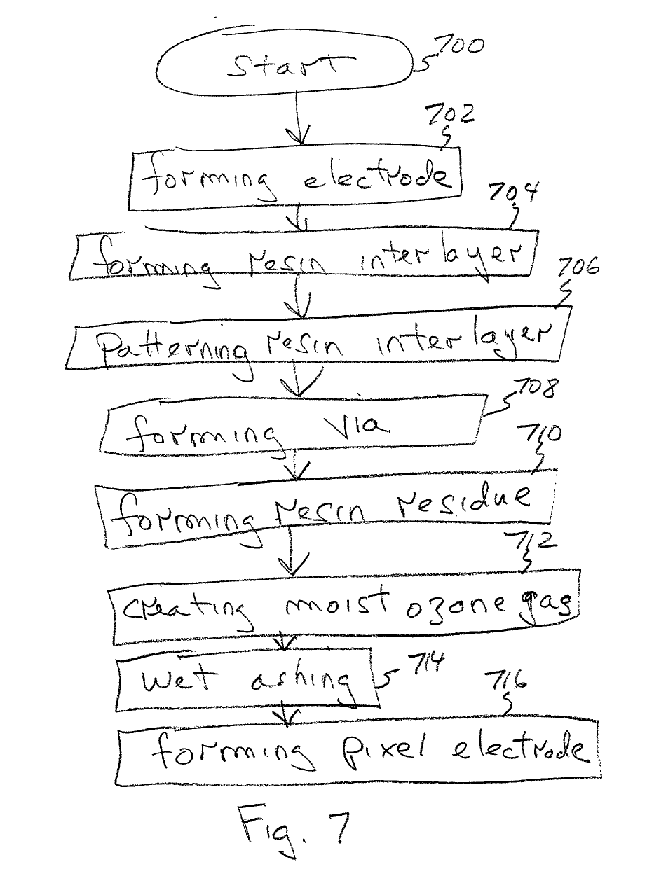

FIG. 6 is a flowchart illustrating an alternate method for repairing a resin interlayer surface in a LCD fabrication process. The method begins at Step 600. Step 602 forms an electrode. Step 604 forms an interlayer film of resin with a surface, overlying an electrode later. Step 606 patterns the resin interlayer. Step 608 dry etches the surface of the resin interlayer to from a via to a first area of the electrode. Step 610, in response to the dry etching, damages the resin interlayer surface. Step 612 introduces a gas mixture including ozone into water to create a moist ozone gas. Step 614 wet ashes the resin interlayer surface using the moist ozone gas. Step 616, in response to wet ashing the resin interlayer surface, repairs the damage caused by the dry etching. Step 618 forms a pixel electrode overlying the first area of the electrode and the surface of the resin interlayer.

FIG. 7 is a flowchart illustrating an alternate method for cleaning a resin residue in a LCD fabrication process. The method begins at Step 700, Step 702 forms an electrode layer. Step 704 forms an interlayer film of resin overlying the electrode later. Step 706 patterns the resin interlayer. Step 708 forms a via to access the first area of the electrode layer. Step 710, in response to forming the via, forms a resin residue overlying the first area of the electrode. Step 712 introduces a gas mixture including ozone into water to create a moist ozone gas. Step 714 wet ashes the resin residue overlying the first area of the electrode layer using the moist ozone gas. Step 716 forms a pixel electrode overlying the first area of the electrode.

A method of removing resin residue, and repairing resin surfaces damaged by dry etching processes, has been provided. The invention has been described in the context of POP LCD processes and bottom gate transistor structure, but the invention is not necessarily limited to this fabrication process or transistor structure. Other variations and embodiments of the invention will occur to those skilled in the art.

We claim:

1. In a liquid crystal display (LCD) fabrication process, a method for cleaning a resin residue, the method comprising:
forming an electrode layer;
forming a resin residue overlying a first area of the electrode layer;
introducing a gas mixture including ozone into water to create a moist ozone gas; and,
wet ashing the resin residue overlying the first area of the electrode layer using the moist ozone gas.

2. The method of claim 1 further comprising:
following the forming of an electrode layer, forming an interlayer film of resin overlying the electrode later;
patterning the resin interlayer;
forming a via to access the first area of the electrode layer; and,
wherein forming a resin residue overlying a first area of the electrode layer includes forming a resin residue in response to forming the via.

3. The method of claim 1 wherein forming an interlayer film of resin overlying an electrode layer includes forming an interlayer film of resin having a thickness in the range of 100 to 1000 Angstroms (Å).

4. The method of claim 1 wherein introducing a gas mixture including ozone into water to create a moist ozone gas includes introducing a gas mixture of approximately 10% ozone by molecular weight (wt %).

5. The method of claim 4 wherein introducing a gas mixture including ozone into water to create a moist ozone gas includes heating the water to a temperature of approximately 90 degrees C.

6. The method of claim 1 further comprising:
following wet ashing the resin residue overlying the first area of the electrode layer using the ozonated water, depositing a metal layer overlying the first area of the electrode to form a pixel electrode.

7. The method of claim 6 wherein depositing a metal layer overlying the first area of the electrode to form a pixel electrode includes depositing a metal layer material selected from the group including indium tin oxide (ITO) and aluminum overlying molybdenum.

8. The method of claim 1 wherein wet ashing the resin residue overlying the first area of the electrode layer using the moist ozone gas includes etching the resin residue at a rate of 200 Å per minute.

9. In a liquid crystal display (LCD) fabrication process, a method for repairing a resin interlayer surface, the method comprising:
forming an interlayer film of resin with a surface;
dry etching the surface of the resin interlayer;
in response to dry etching, damaging the resin interlayer surface;
introducing a gas mixture including ozone into water to create a moist ozone gas;
wet ashing the resin interlayer surface using the moist ozone gas; and,
in response to wet ashing the resin interlayer surface, repairing the damage caused by the dry etching.

10. The method of claim 9 further comprising:
prior to forming an interlayer film of resin, forming an underlying electrode layer;
following the forming of the interlayer film of resin, patterning the resin interlayer; and,
wherein dry etching the resin interlayer includes forming a via to access a first area of the electrode layer using a dry etching process.

11. The method of claim 9 wherein forming an interlayer film of resin includes forming an interlayer film of resin having a thickness in the range of 100 to 1000 Angstroms (Å).

12. The method of claim 9 wherein introducing a gas mixture including ozone into water to create a moist ozone gas includes introducing a gas mixture of approximately 10% ozone by molecular weight (wt %).

13. The method of claim 12 wherein introducing a gas mixture including ozone into water to create a moist ozone gas includes heating the water to a temperature of approximately 90 degrees C.

14. The method of claim 9 further comprising:
following wet ashing the resin interlayer surface using the moist ozone gas, depositing a metal layer overlying the resin interlayer surface and the first area of the electrode to form a pixel electrode.

15. The method of claim 14 wherein depositing a metal layer overlying the resin interlayer surface and the first area of the electrode to form a pixel electrode includes depositing a metal layer material selected from the group including indium tin oxide (ITO) and aluminum overlying molybdenum.

16. The method of claim 9 wherein wet ashing the resin interlayer surface using the moist ozone gas includes etching the resin interlayer surface at a rate of 200 Å per minute.

17. The method of claim 9 wherein wet ashing the resin interlayer surface using the moist ozone gas includes etching the resin interlayer surface a thickness in the range of 100 to 500 Å.

18. The method of claim 9 wherein dry etching the surface of the resin interlayer includes dry etching with a plasma including CF4 and O2.

19. In a liquid crystal display (LCD) fabrication process, a method for repairing a resin interlayer surface, the method comprising:
forming an electrode;
forming an interlayer film of resin with a surface, overlying an electrode later;
patterning the resin interlayer;
dry etching the surface of the resin interlayer to from a via to a first area of the electrode;
in response to dry etching, damaging the resin interlayer surface;
introducing a gas mixture including ozone into water to create a moist ozone gas;
wet ashing the resin interlayer surface using the moist ozone gas;
in response to wet ashing the resin interlayer surface, repairing the damage caused by the dry etching; and,
forming a pixel electrode overlying the first area of the electrode and the surface of the resin interlayer.

20. In a liquid crystal display (LCD) fabrication process, a method for cleaning a resin residue, the method comprising:
forming an electrode layer;
forming an interlayer film of resin overlying the electrode later;
patterning the resin interlayer;
forming a via to access the first area of the electrode layer;
in response to forming the via, forming a resin residue overlying the first area of the electrode;
introducing a gas mixture including ozone into water to create a moist ozone gas;
wet ashing the resin residue overlying the first area of the electrode layer using the moist ozone gas; and,
forming a pixel electrode overlying the first area of the electrode.
